(19) United States
(12) Patent Application Publication
(10) Pub. No.: US 2011/0095739 A1
(43) Pub. Date: Apr. 28, 2011

(54) SEPARATE TYPE CONVERTER HAVING RELATIVELY BETTER EFFECTIVENESS

(75) Inventors: Jen-Ta SU, Taoyuan Hsien (TW); Hsin-Liang LIN, Taoyuan Hsien (TW); Chung-Cheng CHANG, Taoyuan Hsien (TW); Pei-Sheng LIAO, Taoyuan Hsien (TW)

(73) Assignee: DELTA ELECTRONICS, INC., Taoyuan Hsien (TW)

(21) Appl. No.: 12/915,960

(22) Filed: Oct. 29, 2010

Related U.S. Application Data
(63) Continuation of application No. 11/772,421, filed on Jul. 2, 2007.

(30) Foreign Application Priority Data
Nov. 14, 2006 (TW) 095142159

(51) Int. Cl. G05F 1/00

(52) U.S. Cl. 323/282

(57) ABSTRACT

A separate type converter is provided. The separate type converter includes a power control module having a power control circuit generating a first control signal, and a power stage module having a power stage circuit coupled to the power control circuit for receiving the first control signal and an input voltage, and generating an output voltage, in which the power control module and the power stage module are separate from each other in an assembling structure.

### CROSS REFERENCE TO RELATED APPLICATIONS

This application is a continuation of U.S. patent application Ser. No. 11/772,421, filed Jul. 2, 2007, the entire contents which are incorporated by reference as if fully set forth.

### FIELD OF INVENTION

The present invention relates to a separate type converter, and more particular to a separate type converter having a power control module and a power stage module.

### BACKGROUND

It is the trend of the power supply development to increase the power density, efficiency and reliability and to lower the cost. In order to increase the power density, the volume of the power supply is decreased by increasing the operation frequency of the power converter. The interior heat-dissipating condition of the power converter drops owing to the decreased volume, and the noise interference among the power converters are increased owing to the increased operation efficiency.

The cost to be lowered includes the fabrication cost and the design cost, so that the power development should be flexibly designed. In order to meet above-mentioned requirements, the internal arrangement of the power converter should be considered. For example, the internal arrangement of the point of load converter (POL) is illustrated as follows.

Please refer to FIG. 1(a) showing the point of load converter including a PMBus element 11, a pulse-width modulator (PWM) 12, a driver 13, a first switch 14, a second switch 15, a choke L and an output capacitor C. The PMBus element 11 and the PWM 12 are sensitive to the heat and the noise in the surroundings. The driver 13, the switch 14, the switch 15 and the chock L produce lots of heat and noise. In order to improve the performance, effect and reliability and to lower the cost of the power converter, it is to be considered by one skilled in the art to separate the elements sensitive to the heat and the noise from the elements producing the heat and the noise. However, all the elements are arranged together without any separation in the prior art.

FIG. 1(a) is a circuit diagram showing the conventional point of load converter 1 having the “slave” type single in-line package (SIP) according to the prior art. As shown in FIG. 1(a), the point of load converter 1 includes the PMBus element 11, the pulse-width modulator (PWM) 12, the driver 13, the first switch 14, the second switch 15, the choke L, the output capacitor C and the “slave” type single in-line package 16. The PMBus element 11 is used for receiving an input signal of an external PMBus and generating a first control signal. The pulse-width modulator 12 is coupled to the PMBus element 11 for receiving the first control signal and generating a pulse-width modulation signal. The driver 13 is coupled to the pulse-width modulator 12 for receiving a power voltage Vcc and the pulse-width modulation signal and generating a first driving signal Vg1 and a second driving signal Vg2. The first switch 14 has a first terminal, a second terminal and a control terminal, in which the first terminal is used for receiving an input voltage Vin, and the control terminal is coupled to the driver 13 for receiving the first driving signal Vg1. The second switch 15 has a first terminal, a second terminal and a control terminal, in which the first terminal is coupled to the second terminal of the switch 14, the second terminal of the second switch 15, the driver 13 and the pulse-width modulator 12 are coupled to a common ground GND, the control terminal of the second switch 15 is coupled to the driver 13 for receiving the second driving signal Vg2. The choke L has a first terminal and a second terminal, in which the first terminal is coupled to the first terminal of the second switch 15. The output capacitor C has a first terminal and a second terminal for outputting an output voltage Vout, in which the first terminal is coupled to the second terminal of the choke L, and the second terminal is coupled to the common ground GND. The “slave” type single in-line package 16 contains the elements except the PMBus in the point of load converter 1. Please refer to FIG. 1(b) showing the “slave” type single in-line package 16, the topology partition of the point of load converter 1, according to the prior art, in which all the elements of the point of load converter 1 are arranged on the common circuit plate connected to another circuit plate via the surface mounted device, pins and through hole pins. According to the conventional topology partition, for the point of load converter having the “slave” type single in-line package, the chips sensitive to the heat and the noise are close to the MOSFET switches producing the heat and the noise, and the distances among the elements are limited by the heat, so that the space effect is not optimized and the current density per area is low. In addition, while the point of load converter 1 having the “slave” type single in-line package is connected to the motherboard, the operation of the print circuit plate under the “slave” type single in-line package would be interfered owing to the too many pins.

Please refer to FIG. 2(a) showing the point of load converter 2 having the integrated silicon module and the choke module according to the prior art. In FIG. 2(a), the point of load converter 2 includes a PMBus element 11, a pulse-width modulator 12, a driver 13, a first switch 14, a second switch 15, a choke L and an output capacitor C, the PMBus element 11, the pulse-width modulator 12, the driver 13, the first switch 14, the second switch 15 are contained in an integrated silicon module 21, and the choke L is contained in a choke module 22. The operation of the point of load converter 2 is similar to that of the point of load converter 1 shown in FIG. 1(a). For the topology partition of the point of load converter 2, the integrated silicon module 21 is packaged in the application-specific integrated circuit according to the prior art, and the structures of the integrated silicon module 21 and the choke module 22 are shown in FIG. 2(b). For the conventional point of load converter 2 having the integrated silicon module and the choke module, the chips sensitive to the heat and the noise are close to the MOSFET switches producing the heat and the noise, the converter could not be compatible to any other devices, so that the converter could not be used for the advanced MOSFET technology in the future. In addition, while the circuit is assembled on the motherboard, the motherboard is significantly influenced by the noise and the heat from the switches.

In order to overcome the disadvantages of the prior art described above, the present invention provides a separate type converter.

### SUMMARY

It is an aspect of the present invention to provide a separate type converter having the better effectiveness in order to achieve higher power/current density per area, eliminate the noise from the switch to the motherboard, lower the heat conducted to the motherboard, be digital controlled and be compatible with the analog control.

The present invention provides a separate type converter, including a power control module having a power control circuit generating a first control signal, and a power stage module having a power stage circuit coupled to the power control circuit for receiving the first control signal and an input voltage, and generating an output voltage, in which the power control module and the power stage module are separate from each other in an assembling structure.

In accordance with the present invention, the power control module and the power stage module are separate from each other in the assembling structure by means of that the power control module and the power stage module are disposed in different carriers and/or packages.

In accordance with the present invention, the separate type converter is one of DC/DC converter and an AC/DC converter.

In accordance with the present invention, the DC/DC converter is one selected from a group consisting of a boost converter, a buck converter, a buck-boost converter, a flyback converter and a point of load converter.

In accordance with the present invention, the DC/DC converter is a point of load converter, the first control signal is a pulse-width modulation signal, and the power control circuit further includes a digital controller having a PMBus element for receiving an input signal outputted from an external PMBus and generating a second control signal, and a pulse-width modulator coupled to the PMBus element for receiving the second control signal and generating the pulse-width modulation signal, in which the power stage circuit includes a driver coupled to the pulse-width modulator for receiving a supply voltage and the pulse-width modulation signal and generating a first and a second driving signals, and a power stage coupled to the driver for receiving the first and the second driving signals and generating the output voltage and having a first switch having a first terminal for receiving the input voltage, a second terminal and a control terminal coupled to the driver and receiving the first driving signal, a second switch having a first terminal coupled to the second terminal of the first switch, a second terminal coupled to the driver, the pulse-width modulator and a common ground, and a control terminal coupled to the driver and receiving the second driving signal, an inductor having a first terminal coupled to the first terminal of the second switch and a second terminal, and an output capacitor having a first terminal coupled to the second terminal of the inductor and a second terminal coupled to the common ground, and outputting the output voltage.

In accordance with the present invention, the first and the second switch are MOSFETs, and the first, the second and the control terminals of each of the first and the second switches are a drain, a source and a gate of the MOSFETs respectively.

In accordance with the present invention, the input voltage is provided by an intermediate bus converter.

In accordance with the present invention, the DC/DC converter is a point of load converter, the first control signal is a pulse-width modulation signal, and the power control circuit further includes an analog control circuit for generating a second control signal and a pulse-width modulator coupled to the analog control circuit for receiving the second control signal and generating the pulse-width modulation signal.

In accordance with the present invention, the input voltage is an AC input voltage, the output voltage is a DC output voltage, and the AC/DC converter further includes a PFC circuit for receiving the AC input voltage and generating the DC output voltage.

In accordance with the present invention, the input voltage is an AC input voltage, the output voltage is a DC output voltage, and the AC/DC converter further includes a dual PFC circuit for receiving the AC input voltage and generating the DC output voltage.

In accordance with the present invention, there are at least a first PCB and a second PCB in the different carriers, in which the power control module is installed on the first PCB, and the power stage module is installed on the second PCB.

In accordance with the present invention, the carrier is a PCB, the package is a system chip package, the power control module is installed on the PCB, and the power stage module is packaged into the system chip package to form a system chip.

It is another aspect of the present invention to provide a separate type converter including a power control module having a power control circuit for generating a first control signal having a control unit for generating a second control signal, and a pulse-width modulator coupled to the control unit for receiving the second control signal and generating the first control signal, and a power stage module for receiving the first control signal and an input voltage and generating an output voltage having a power stage circuit including a driver coupled to the power control circuit for receiving the first control signal and generating a first and a second driving signals, and a power stage coupled to the driver for receiving the first and the second driving signals and generating the output voltage, in which the power control module and the power stage module are separate from each other in an assembling structure.

In accordance with the present invention, the power control module and the power stage module are separate from each other in the assembling structure by means of that the power control module and the power stage module are installed in different carriers and/or packages, respectively.

In accordance with the present invention, the different carriers comprise a first PCB and a second PCB, the first PCB has a first surface, a second surface and a plurality of SMD pins, the power stage module is installed on the first surface of the first PCB, the second PCB has a first surface and a second surface, the plurality of SMD pins are installed between the second surface of the first PCB and the first surface of the second PCB to connect the first PCB and the second PCB, and the power control module is installed on the second surface of the second PCB.

It is another aspect of the present invention to provide a separate type converter, including a power stage module having a power stage circuit for receiving a control signal and an input voltage and generating an output voltage, in which the power stage module is separate from other circuits of the converter in an assembling structure.

In accordance with the present invention, the power stage module is separate from other circuits in the assembling structure by means of that the power stage module is installed on one of a carrier and a carrier including a package.

In accordance with the present invention, the converter further includes a power control circuit.

### BRIEF DESCRIPTION OF THE DRAWINGS

The above aspects and advantages of the present invention will become more readily apparent to those ordinarily skilled in the art after reviewing the following detailed description and accompanying drawings, in which:

FIG. 1(a) is the circuit diagram showing the point of load converter having the “slave” type single in-line package in the prior art;

FIG. 1(b) shows the structure of the point of load converter having the “slave” type single in-line package shown in FIG. 1(a);

FIG. 2(a) is the circuit diagram showing the point of load converter having the integrated silicon module and the choke module in the prior art;

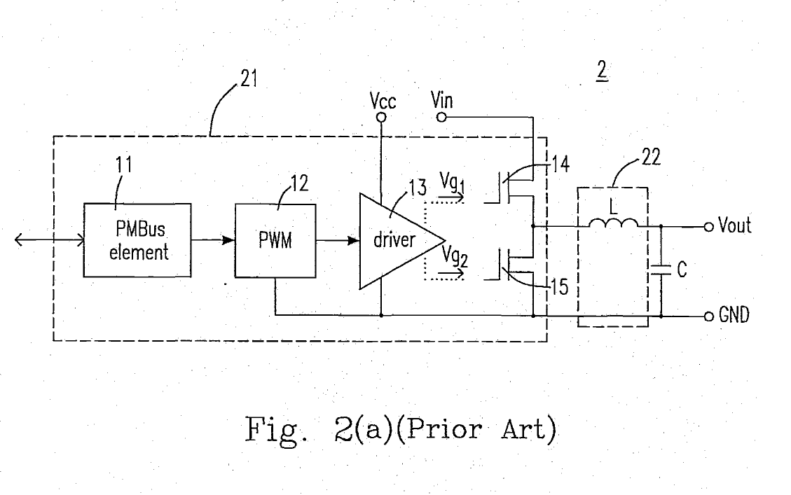

FIG. 2(b) shows the structure of the point of load converter having the integrated silicon module and the choke module shown in FIG. 2(a);

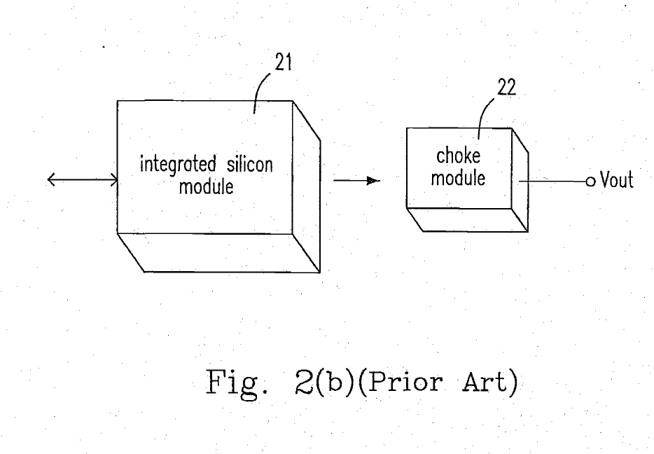

FIG. 3(a) is the circuit diagram showing the point of load converter having the power control module and the power stage module according to the first preferred embodiment of the present invention;

FIG. 3(b) shows the structure of the point of load converter having the power control module and the power stage module shown in FIG. 3(a);

FIG. 4(a) is the circuit diagram showing the point of load converter having the power control module and the power stage module according to the second preferred embodiment of the present invention;

FIG. 4(b) shows the structure of the point of load converter having the power control module and the power stage module shown in FIG. 4(a);

FIG. 5 is the schematic view showing the point of load converter having the power control module and the power stage module on the motherboard according to the first preferred embodiment of the present invention; and

FIG. 6 is the circuit diagram showing the AC/DC converter having a power control module and a power stage module according to the third preferred embodiment of the present invention.

### DETAILED DESCRIPTION OF THE PREFERRED EMBODIMENTS

The invention is described more specifically with reference to the following embodiments. It is to be noted that the following descriptions of preferred embodiments of this invention are presented herein for the purpose of illustration and description only, it is not intended to be exhaustive or to be limited to the precise form disclosed.

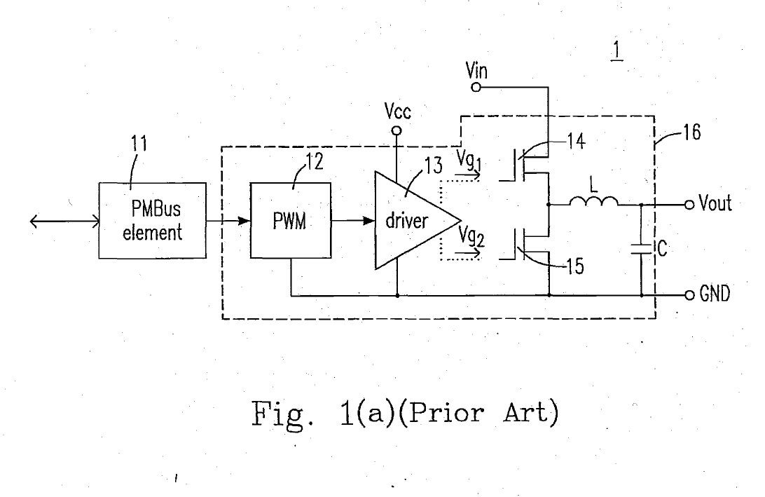

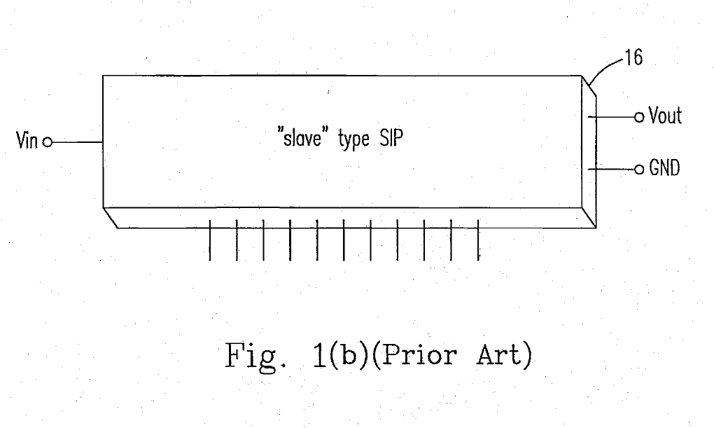

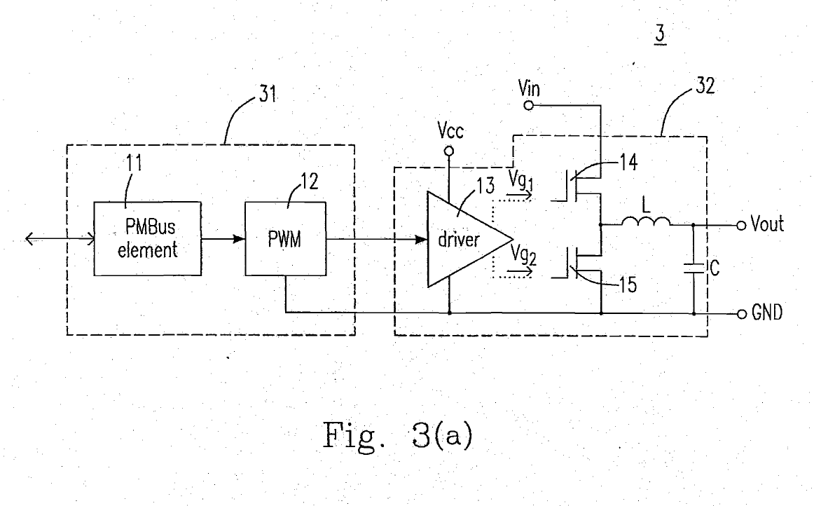

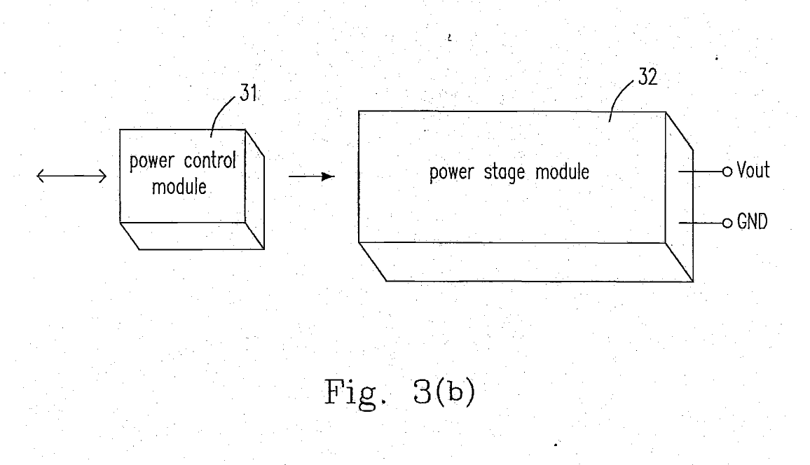

Please refer to FIG. 3(a) showing the point of load converter 3 having the power control module and the power stage module according to the first preferred embodiment of the present invention. In FIG. 3(a), the point of load converter 3 includes a PMBus element 11, a pulse-width modulator 12, a driver 13, a first switch 14, a second switch 15, a choke L and an output capacitor C, the PMBus element 11 and the pulse-width modulator 12 are contained in a power control module 31 and formed as a power control circuit (a digital controller in the first preferred embodiment), and the driver 13, the first switch 14, the second switch 15, and choke L and the output capacitor C are contained in a power stage module 32 and formed as a power stage circuit. The digital timing, tracking, sequencing, and telemetry and calculation of the output voltage Vout, an output current (not shown) and an internal temperature of the converter are performed by the point of load converter 3 by using the digital controller. The design of the point of load converter 3 is flexible in response to the requirements. The operations of the input, output and connection of the point of load converter 3 are similar to those of the conventional point of load converter 1 shown in FIG. 1(a).

The power control module 31 and the power stage module 32 are respectively installed in difference carriers or in different packages. It means that the power control module 31 and the power stage module 32 are installed in difference carriers, installed in different packages, or installed in different carriers and packages, so as to separate the power control module 31 from the power stage module 32. The carriers are used for the circuit elements to be connected thereon such as a PCB or a substrate in the system in package or system on package. The package can be the system on chip package or the system package. Please refer to FIG. 3(b) showing the structure of the point of load converter having the power control module and the power stage module. All the elements in the power control module 31 are arranged in a first carrier, such as a first PCB, and all the elements in the power stage module 32 are arranged in a second carrier, such as a second PCB, in which the electrical connection is performed via the corresponding pins, such as the SMD pins. Since the power control module 31 has a first PCB for receiving the PMBus element 11 and the pulse-width modulator 12, and the power stage module 32 has a second PCB for receiving the driver 13, the first switch 14, the second switch 15, the choke L and the output capacitor C (the output capacitor C could be a capacitor outside the power stage module 32), so that the power control module 31 is separate from the power stage module 32. In order to improve the performance of the converter, the elements sensitive to the heat and the noise should be separate from the element producing the heat and the noise. Hence, the advantages of the point of load converter 3 having the power control module and the power stage module are as follows. The elements sensitive to the heat and the noise are separate from the element producing the heat and the noise, so that the point of load converter 3 has the higher power-current density per area and the better anti-interference performance. All the power elements are contained in the power stage module 32 having the second PCB, and the heat produced in the power stage module 32 is dissipated by the heat-dissipating device installed in the power stage module 32. The point of load converter 3 only has the SMD pins but not the through hole pins, and is connected to the motherboard via the SMD pins, so that the connection of the point of load converter 3 having the power control module and the power stage module and the motherboard can be applied (for example, data routing can be performed under the connection). The PMBus element 11 of the power control module 31 can be replaced with an analog control circuit, so as to be compatible with the analog control circuit as illustrated in the second preferred embodiment of the present invention.

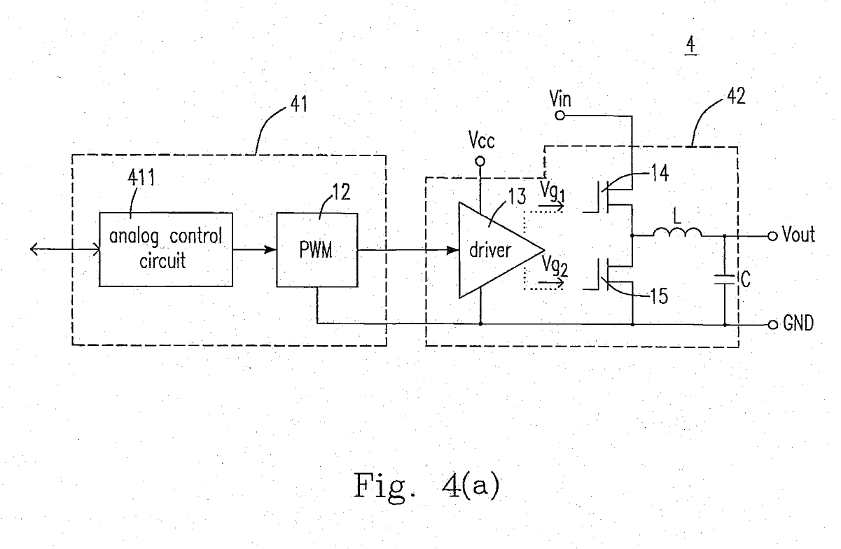

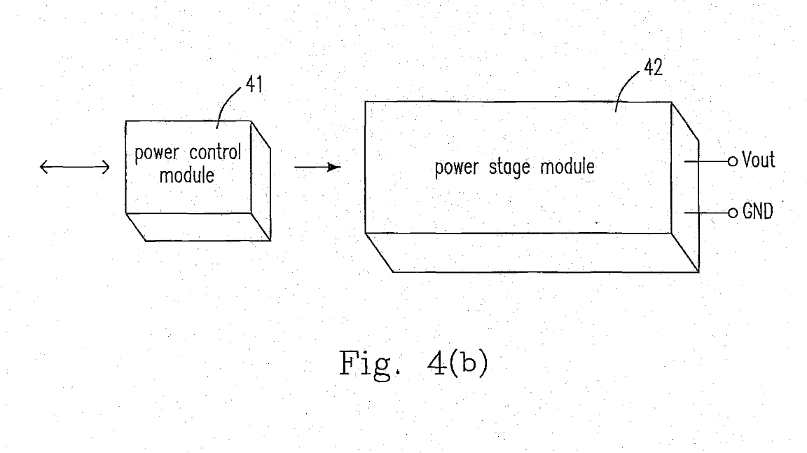

Please refer to FIG. 4(a) showing the point of load converter 4 having the power control module and the power stage module according to the second preferred embodiment of the present invention. In FIG. 4(a), the point of load converter 4 includes an analog control circuit 411, a pulse-width modulator 12, a driver 13, a first switch 14, a second switch 15, a choke L and an output capacitor C, the analog control circuit 411 and the pulse-width modulator 12 are contained in a power control module 41, and the driver 13, the first switch 14, the second switch 15, the choke L and the output capacitor C are contained in a power stage module 42. In addition to the PMBus element 11 in the power control module 31 is replaced with an analog control circuit 411, the operational principles, the input, the output and the circuit connection of the point of load converter 4 having the power control module and the power stage module are similar to those of the point of load converter 3 shown in FIG. 3(a). FIG. 4(b) shows the structure of the point of load converter having the power control module and the power stage module. Therefore, the noise and the heat entering into the motherboard can be eliminated by the point of load converter 4 having the power control module and the power stage module. The connection of the point of load converter 4 having the power control module and the power stage module and the motherboard can be applied. The point of load converter 4 is compatible with the analog control circuit.

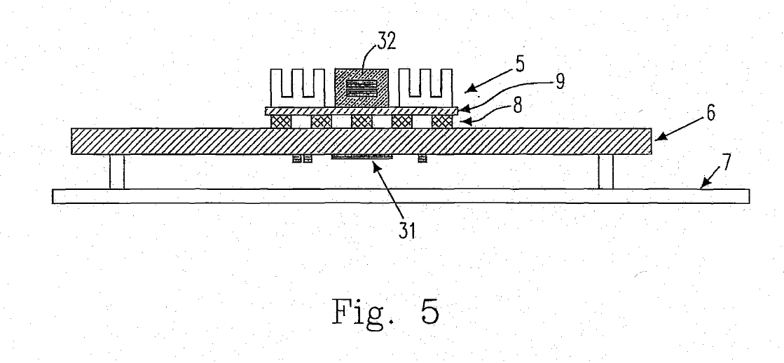

FIG. 5 is the schematic view showing the point of load converter 3 having the power control module 31 and the power stage module 32 on the motherboard 6 according to the first preferred embodiment of the present invention. The power control module 31 and the power stage module 32 are installed in different carriers, so that the power control module 31 is separate from the power stage module 32. Referring to FIG. 5, the elements in the power stage 32 are installed on the PCB 9 (carrier of the power stage module 32), and the power stage module 32 is assembled on the motherboard 6 via the pins 8. The motherboard 6 is disposed on the chassis 7, and at least one heat-dissipating plate 5 is disposed on the side of the power stage module 32. In addition, the power control module 31 is disposed on the other side of the motherboard 6 (carrier of the power stage module 32) under the power stage module 32. Therefore, the space under the point of load converter 3 having the power control module 31 and the power stage module 32 can be used.

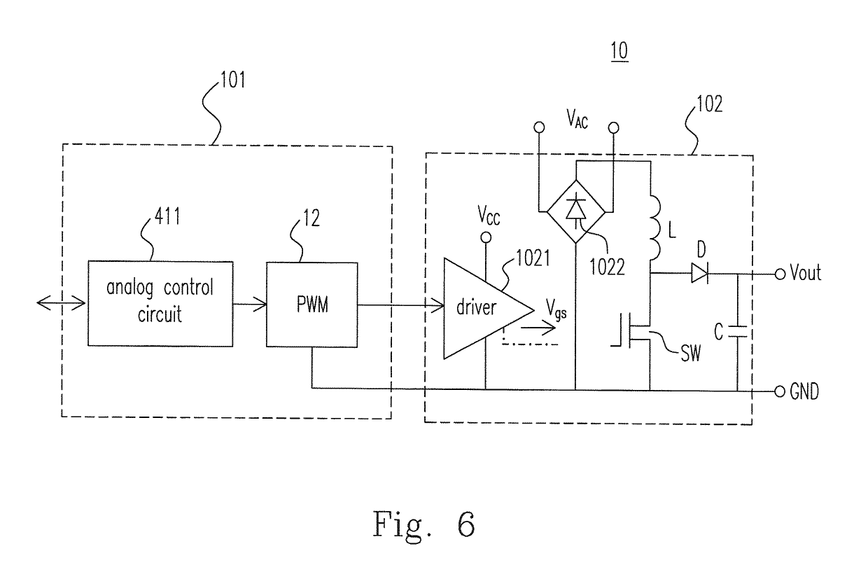

Please refer to FIG. 6 showing the AC/DC converter 10 having a power control module 101 and a power stage module 102 according to the third preferred embodiment of the present invention. In FIG. 6, the AC/DC converter 10 receives an AC input voltage V_{AC}, outputs a DC output voltage Vout, and includes an analog control circuit 411, a pulse-width modulator 12, a driver 1021 generating a driving signal Vgs, a rectifier 1022, a diode D, a switch SW driven by Vgs, a choke L and an output capacitor C, the analog control circuit 411 and the pulse-width modulator 12 are contained in the power control module 101, and the driver 1021, the rectifier 1022, the diode D, the switch SW, the choke L and the output capacitor C are contained in the power stage module 102. The rectifier 1022 receives the AC input voltage V_{AC}, outputs a rectified voltage (not shown) and connects a first terminal of the choke L and the common ground GND. The anode of the diode D connects a second terminal of the choke L and a first terminal of the switch SW, and the cathode of the diode D connects the first terminal of the output capacitor C.

Accordingly, the present invention provides a separate type converter having better performance and higher power/current density per area, and eliminating the noise and the heat entering into the motherboard.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A separate type converter, comprising:
a power control module having a power control circuit generating a first control signal; and
a power stage module having a power stage circuit coupled to the power control circuit for receiving the first control signal and an input voltage, and generating an output voltage, and
separate from the power control module in an assembling structure so that the power control module and the power stage module are installed in different carriers and/or packages, respectively.

2. A separate type converter according to claim 1, wherein the power control module and the power stage module are separate from each other in the assembling structure by means of that the power control module and the power stage module are disposed in different carriers.

3. A separate type converter according to claim 2, further comprising at least a first PCB and a second PCB in the different carriers, wherein the power control module is installed on the first PCB, and the power stage module is installed on the second PCB.

4. A separate type converter according to claim 2, wherein the different carriers comprises at least a PCB and a system in package plate, the power control module is installed on the PCB, and the power stage module is installed on the system in package plate.

5. A separate type converter according to claim 1, wherein the power control module and the power stage module are separate from each other in the assembling structure by means of that the power control module and the power stage module are disposed in different packages.

6. A separate type converter according to claim 1, wherein the power control module and the power stage module are separate from each other in the assembling structure by means of that the power control module and the power stage module are disposed in different carriers and packages.

7. A separate type converter according to claim 6, wherein the carrier is a PCB, the package is a system chip package, the power control module is installed on the PCB, and the power stage module is packaged into the system chip package to form a system chip.

8. A separate type converter according to claim 1, being one of a DC/DC converter and an AC/DC converter.

9. A separate type converter according to claim 8, wherein the DC/DC converter is one selected from a group consisting of a boost converter, a buck converter, a buck-boost converter, a flyback converter and a point of load converter.

10. A separate type converter according to claim 8, wherein the DC/DC converter is a point of load converter, the first control signal is a pulse-width modulation signal, and the power control circuit further comprises a digital controller having:
a PMBus element for receiving an input signal outputted from an external PMBus and generating a second control signal; and
a pulse-width modulator coupled to the PMBus element for receiving the second control signal and generating the pulse-width modulation signal,
wherein the power stage circuit comprises a driver coupled to the pulse-width modulator for receiving a supply voltage and the pulse-width modulation signal and generating a first and a second driving signals, and a power stage coupled to the driver for receiving the first and the second driving signals and generating the output voltage and having:
a first switch having a first terminal for receiving the input voltage, a second terminal and a control terminal coupled to the driver and receiving the first driving signal;
a second switch having a first terminal coupled to the second terminal of the first switch, a second terminal coupled to the driver, the pulse-width modulator and a common ground, and a control terminal coupled to the driver and receiving the second driving signal;
an inductor having a first terminal coupled to the first terminal of the second switch and a second terminal; and
an output capacitor having a first terminal coupled to the second terminal of the inductor and a second terminal coupled to the common ground, and outputting the output voltage,
wherein the first and the second switch are MOSFETs, the first, the second and the control terminals of each of the first and the second switches are a drain, a source and a gate of the MOSFETs respectively, and the input voltage is provided by an intermediate bus converter.

11. A separate type converter according to claim 8, wherein the DC/DC converter is a point of load converter, the first control signal is a pulse-width modulation signal, and the power control circuit further comprises an analog control circuit for generating a second control signal and a pulse-width modulator coupled to the analog control circuit for receiving the second control signal and generating the pulse-width modulation signal, wherein the power stage circuit comprises a driver coupled to the pulse-width modulator for receiving a supply voltage and the pulse-width modulation signal and generating a first and a second driving signals, and a power stage coupled to the driver for receiving the first and the second driving signals and generating the output voltage, and comprising:
a first switch having a first terminal for receiving the input voltage, a second terminal and a control terminal coupled to the driver and receiving the first driving signal;
a second switch having a first terminal coupled to the second terminal of the first switch, a second terminal coupled to the driver, the pulse-width modulator and a common ground, and a control terminal coupled to the driver and receiving the second driving signal;
an inductor having a first terminal coupled to the first terminal of the second switch and a second terminal; and
an output capacitor having a first terminal coupled to the second terminal of the inductor and a second terminal coupled to the common ground, and outputting the output voltage.

12. A separate type converter according to claim 8, wherein the input voltage is an AC input voltage, the output voltage is a DC output voltage, and the AC/DC converter further comprises a PFC circuit for receiving the AC input voltage and generating the DC output voltage.

13. A separate type converter according to claim 8, wherein the input voltage is an AC input voltage, the output voltage is a DC output voltage, and the AC/DC converter further comprises a dual PFC circuit for receiving the AC input voltage and generating the DC output voltage.

14. A separate type converter, comprising:
a power control module, comprising:
a power control circuit for generating a first control signal, comprising:
a control unit for generating a second control signal; and
a pulse-width modulator coupled to the control unit for receiving the second control signal and generating the first control signal; and
a power stage module for receiving the first control signal and an input voltage and generating an output voltage, comprising:
a power stage circuit, comprising:
a driver coupled to the power control circuit for receiving the first control signal and generating a first and a second driving signals; and
a power stage coupled to the driver for receiving the first and the second driving signals and generating the output voltage, and
separate from the power control module in an assembling structure so that the power control module and the power stage module are installed in different carriers and/or packages, respectively.

15. A separate type converter according to claim 14, wherein the power control module and the power stage module are separate from each other in the assembling structure by means of that the power control module and the power stage module are installed in different carriers.

16. A separate type converter according to claim 15, wherein the different carriers comprise a first PCB and a second PCB, the first PCB has a first surface, a second surface and a plurality of SMD pins, the power stage module is installed on the first surface of the first PCB, the second PCB has a first surface and a second surface, the plurality of SMD pins are installed between the second surface of the first PCB and the first surface of the second PCB to connect the first PCB and the second PCB, and the power control module is installed on the second surface of the second PCB.

17. A separate type converter, comprising:
a power control module, comprising:
a power control circuit for generating a first control signal comprising:
a control unit for generating a second control signal; and
a pulse-width modulator coupled to the control unit for receiving the second control signal and generating the first control signal; and
a power stage module for receiving the first control signal and an input voltage and generating an output voltage comprising:
a power stage circuit, comprising:
a driver coupled to the power control circuit for receiving the first control signal and generating a first and a second driving signals; and
a power stage coupled to the driver for receiving the first and the second driving signals and generating the output voltage the power control module and the power stage module are separate from each other in an assembling structure wherein the power control circuit and the power stage are those as claimed in claim 10.

18. A separate type converter, comprising:
a power stage module, comprising:
a power stage circuit for receiving a control signal and an input voltage and generating an output voltage, and
separate from other circuits of the converter in an assembling structure so that the power stage module and the other circuits of the converter are installed in different carriers and/or packages, respectively.

19. A separate type converter according to claim 18, wherein the power stage module is separate from other circuits in the assembling structure by means of that the power stage module is installed on one of a carrier and a carrier comprising a package.

20. A separate type converter, comprising:
a power stage module, comprising:
a power stage circuit for receiving a control signal and an input voltage and generating an output voltage, the power stage module is separate from other circuits of the converter in an assembling structure, the converter further comprising a power control module generating the control signal, and separated from the power stage module and the other circuits, wherein the power control module and the power stage circuit are those as claimed in claim 10.

21. A separate type converter comprising:
a power control module, comprising:
a power control circuit for generating a first control signal, comprising:
a control unit for generating a second control signal; and
a pulse-width modulator coupled to the control unit for receiving the second control signal and generating the first control signal; and
a power stage module for receiving the first control signal and an input voltage and generating an output voltage, comprising:
a power stage circuit, comprising:
a driver coupled to the power control circuit for receiving the first control signal and generating a first and a second driving signals; and
a power stage coupled to the driver for receiving the first and the second driving signals and generating the output voltage, the power control module and the power stage module are separate from each other in an assembling structure wherein the power control circuit and the power stage are those as claimed in claim 11.

22. A separate type converter comprising:
a power stage module, comprising:
a power stage circuit for receiving a control signal and an input voltage and generating an output voltage, the power stage module is separate from other circuits of the converter in an assembling structure, the converter further comprising a power control module generating the control signal, and separated from the power stage module and the other circuits, wherein the power control module and the power stage circuit are those as claimed in claim 11.
